(19) United States
(12) Patent Application Publication
(10) Pub. No.: US 2026/0188278 A1
(43) Pub. Date: Jul. 2, 2026

(54) DATA DRIVER AND DISPLAY DEVICE INCLUDING THE SAME

(71) Applicant: LG Display Co., Ltd., Seoul (KR)

(72) Inventors: Jea Hun JUNG, Paju-si (KR); Seong Ho YUN, Paju-si (KR); Sang Hwa LEE, Paju-si (KR)

(73) Assignee: LG Display Co., Ltd., Seoul (KR)

(21) Appl. No.: 19/380,585

(22) Filed: Nov. 5, 2025

(30) Foreign Application Priority Data
Dec. 30, 2024 (KR) 10-2024-0199518

(51) Int. Cl. G09G 3/36

(52) U.S. Cl. CPC G09G 3/3688; G09G 2310/027; G09G 2310/08; G09G 2330/021

(57) ABSTRACT

A data driver according to an embodiment and a display device including the same are disclosed. The data driver includes a voltage output circuit including a first amplifier configured to amplify input positive pixel data and output the amplified positive pixel data as a positive data voltage and a second amplifier configured to amplify negative pixel data and output the amplified pixel data as a negative data voltage; a selection circuit configured to alternately connect the first amplifier and the second amplifier to a first data line and a second data line, and connect the first and second data lines before polarities of data voltages that are applied to the first and second data lines are inverted; and a control circuit configured to vary a charge sharing time for connecting the first and second data lines and performing charge sharing according to change in grayscale of the input pixel data.

### CROSS-REFERENCE TO RELATED APPLICATION

This application claims priority to and the benefit of Korean Patent Application No. 10-2024-0199518, filed Dec. 30, 2024, the disclosure of which is incorporated herein by reference in its entirety.

### BACKGROUND

### Technical Field

The present disclosure relates to a data driver and a display device including the same.

### Description of the Related Art

Display devices includes a liquid crystal display (LCD) device, an electroluminescence display device, a field emission display (FED) device, a plasma display panel (PDP), and the like.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a scan signal or a gate signal to the display panel, and a data driver that supplies a data signal to the display panel.

A liquid crystal display is driven by an inversion method for controlling data voltages charged in adjacent subpixels to be opposite in polarity and cyclically inverting the polarities of the data voltages. When the liquid crystal display is driven by the inversion method, since the polarities of the data voltages should be cyclically inverted, power consumption is large. To reduce power consumption, charge sharing between adjacent data lines is performed by connecting adjacent data lines to which data voltages with different polarities are applied.

### BRIEF SUMMARY

Inventors recognized that when charge sharing is performed, current consumption is different according to the grayscale of pixel data, and in particular, when a time for charge sharing at a high grayscale is not sufficient, since charge is not completely moved between adjacent data lines, the amount of charge is small in a portion far from an input side of a data line to which a data voltage is applied, compared to a portion close to the input side, and a current may rapidly increase in next data voltage application.

The present disclosure provides a data driver capable of reducing current consumption and a display device including the same.

It should be noted that features of the present disclosure are not limited to the above-described objects, and other features of the present disclosure will be apparent to those skilled in the art from the following descriptions.

A data driver according to embodiments of the present disclosure may include a voltage output circuit including a first amplifier configured to amplify input positive pixel data and output the amplified positive pixel data as a positive data voltage and a second amplifier configured to amplify negative pixel data and output the amplified pixel data as a negative data voltage; a selection circuit configured to alternately connect the first amplifier and the second amplifier to a first data line and a second data line, and connect the first and second data lines before polarities of data voltages that are applied to the first and second data lines are inverted; and a control circuit configured to vary a charge sharing time for connecting the first and second data lines and performing charge sharing according to change in grayscale of the input pixel data.

A display device according to embodiments of the present disclosure may include a display panel in which a plurality of data lines, a plurality of gate lines, and a plurality of pixel circuits are provided; a data driver configured to output data voltages to the plurality of data lines; and a gate driver configured to output gate signals to the plurality of gate lines, wherein the data driver includes: a voltage output circuit including a first amplifier configured to amplify input positive pixel data and output the amplified positive pixel data as a positive data voltage and a second amplifier configured to amplify negative pixel data and output the amplified pixel data as a negative data voltage; a selection circuit configured to alternately connect the first amplifier and the second amplifier to a first data line and a second data line, and connect the first and second data lines before polarities of data voltages that are applied to the first and second data lines are inverted; and a control circuit configured to vary a charge sharing time for connecting the first and second data lines and performing charge sharing according to change in grayscale of the input pixel data.

According to the embodiments of the present disclosure, in a charge sharing mode where adjacent data lines are short-circuited after pixel data of a high grayscale is applied, by supplying the voltage of the predetermined level while extending the charge sharing time by the predetermined time, it is possible to sufficiently secure the charge sharing time until the voltage of the predetermined level is reached.

According to the embodiments of the present disclosure, since the voltage of the predetermined level can be reached during charge sharing at the high grayscale where a relatively large number of charges is moved, current consumption can be reduced.

According to the embodiments of the present disclosure, since current consumption can be reduced, low power driving can be achieved.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a diagram illustrating a configuration of a data driver according to the embodiment of the present disclosure;

FIG. 3 is a diagram illustrating a driving voltage that is supplied to an amplifier illustrated in FIG. 2;

FIGS. 4 and 5 are diagrams illustrating an operation principle of a selection circuit in a display mode;

FIGS. 6 to 9 are diagrams illustrating an operation principle of the selection circuit in a charge sharing mode;

FIG. 10 is a diagram illustrating a grayscale determination principle according to the embodiment of the present disclosure; and

FIGS. 11 and 12 are diagrams illustrating a data packet according to the embodiment of the present disclosure.

### DETAILED DESCRIPTION

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification includes those disclosed in the claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to,’ and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

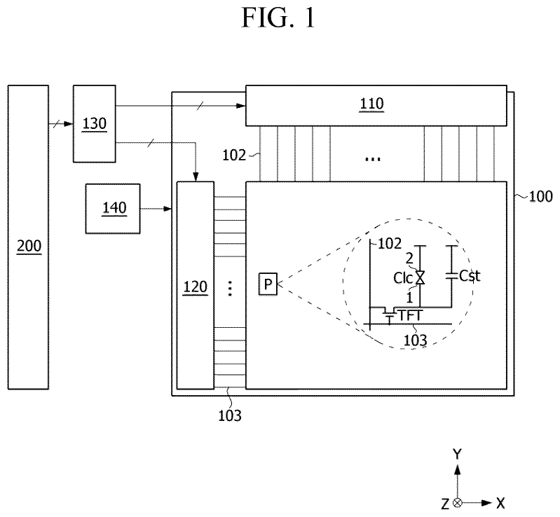

FIG. 1 is a block diagram illustrating a display device according to an embodiment of the present disclosure.

Referring to FIG. 1, a display device according to an embodiment of the present disclosure includes a display panel 100, and a display panel driving circuit for writing pixel data to pixels of the display panel 100. The display device further includes a power supply 140. A backlight unit for light irradiation may be provided below the display panel 100.

The display panel 100 includes an upper substrate and a lower substrate facing each other with a liquid crystal layer interposed therebetween. A pixel array includes a plurality of data lines 102, a plurality of gate lines 103 intersecting the data lines 102, and pixels provided in a matrix. n (where n is a natural number) data lines 102 include n/2 odd-numbered data lines that supply data voltages to n subpixels and n/2 even-numbered data lines that supply data voltages to the n subpixels. Each data line is connected to two subpixels positioned one pixel line. Each of the subpixels positioned in each pixel line is connected to one of a pair of gate lines.

In the lower substrate of the display panel 100, the data lines 102, the gate lines 103, TFTs, pixel electrodes 1 connected to the TFTs, and storage capacitors Cst connected to the pixel electrodes 1 are provided. Each pixel displays an image of video data by adjusting an amount of light transmission using liquid crystal molecules that are driven by a voltage difference between the pixel electrode 1 charged with the data voltage via the TFT and a common electrode 2 to which a common voltage is applied.

In the upper substrate of the display panel 100, a color filter array including a black matrix and color filters is formed. The common electrode 2 may be formed on the upper substrate in the case of a vertical field driving mode such as a twisted nematic (TN) mode and a vertical alignment (VA) mode, and may be formed along with the pixel electrode on the lower substrate in the case of a horizontal field driving mode such as an in-plane switching (IPS) mode and a fringe field switching (FFS) mode.

A liquid display device of the present disclosure may be implemented in any forms such as a transmissive liquid display device, a half-transmissive liquid display device, and a reflective liquid display device. In the transmissive liquid crystal display and the semi-transmissive liquid display device, a backlight unit is included. The backlight unit may be implemented by a direct type backlight unit or an edge type backlight unit.

Each of the pixels P may be divided into a red sub-pixel, a green sub-pixel, and a blue sub-pixel for color implementation. Each pixel may further include a white sub-pixel.

The power supply 140 receives an input voltage applied from the host system 200 and outputs a voltage needed to drive the pixels P of the display panel 100 and the display panel driving circuit.

The display panel driving circuit writes pixel data of the input image to the pixels P under the control of the timing controller 130. The display panel driving circuit includes a data driver 110 and a gate driver 120.

The data driver 110 converts input image data into a positive/negative gamma compensation voltage and outputs a positive/negative gamma data voltage under the timing controller 130. The data driver 110 applies data voltages with opposite polarities to the odd-numbered data lines and the even-numbered data lines. For example, the data driver 110 supplies a positive (+) data voltage to the odd-numbered data lines and supplies a negative (−) data voltage to the even-numbered data lines.

The data driver 110 may adjust a time for charge sharing between two data lines to which the positive data voltage and the negative data voltage, that is, a charge sharing time. For example, the data driver 110 may apply a first charge sharing time set to a predetermined reference time on the basis of time information received from the timing controller or may apply a second charge sharing time set to be longer than the first charge sharing time.

The gate driver 120 sequentially supplies gate pulses to the gate lines 103 under the control of the timing controller 130. The gate pulses output from the gate driver 120 may be synchronized with a positive/negative video data voltage that will be charged in the pixels.

The timing controller 130 receives digital video data of an input image and a timing signal synchronized with this data from the host system 200. The timing signal may include a vertical synchronization signal Vsync, a horizontal synchronization signal Hsync, and a data enable signal DE.

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The timing controller 130 may generate a data packet including time information for setting a charge sharing time to execute charge sharing according to the electrical characteristics of the display device and may transmit the generated data packet to the data driver 110. The time information for setting the charge sharing time may be stored in an internal memory of the timing controller 130.

The host system 200 may include a main board of one of a television system, a set-top box, a navigation system, a personal computer (PC), a vehicle system, a mobile terminal, and a wearable terminal. The host system 200 may scale an image signal from a video source according to the resolution of the display panel 100, and may transmit it to the timing controller 130 together with the timing signals.

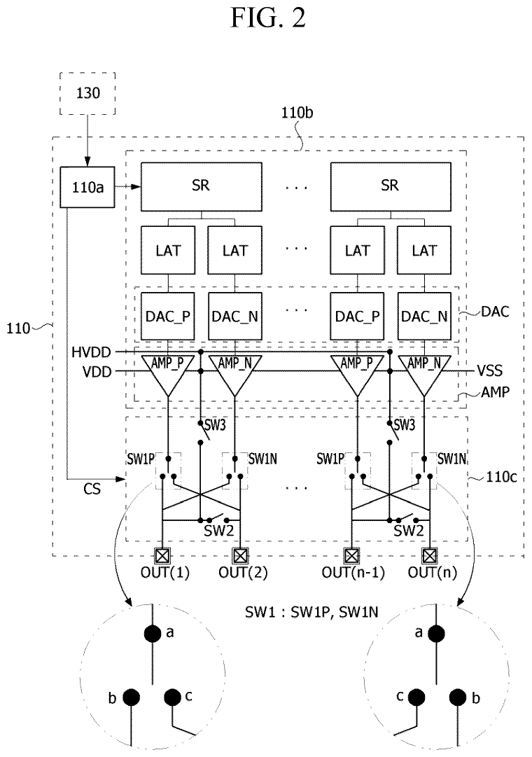

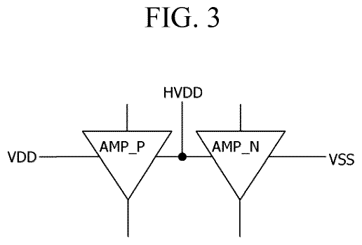

FIG. 2 is a diagram illustrating a configuration of a data driver according to the embodiment of the present disclosure and FIG. 3 is a diagram illustrating a driving voltage that is supplied to an amplifier illustrated in FIG. 2.

Referring to FIG. 2, a data driver 110 according to a first embodiment of the present disclosure may include a control circuit 110a, an output circuit 110b, and a selection circuit 110c. The data driver 110 described herein may be applied to a liquid crystal display, but the embodiments of the present disclosure are not limited thereto.

The control circuit 110a generates a control signal for controlling the selection circuit 110c on the basis of data transmitted from the timing controller 130 and may transmit the control signal to the selection circuit 110c.

The output circuit 110b may include shift registers SR, latches LAT, DA converters DAC, and amplifiers AMP.

The shift register SR may shift a clock input from the timing controller 130 to generate a sampling clock, and may sequentially output the generated sampling clock to the latches LAT.

The latches LAT may sample and store pixel data of the input image according to the timing of the sequentially input sampling clock, and may simultaneously output the stored pixel data.

The DA converter DAC may convert image data with a converted voltage level in an analog form. The DA converter DAC may include a positive DA converter DAC_P and a negative DA converter DAC_N.

The positive DA converter DAC_P may convert pixel data with a converted voltage level into a positive (+) data voltage in an analog form, and the negative DA converter DAC_N may convert pixel data with a converted voltage level into a negative (−) data voltage.

The amplifier AMP may amplify a voltage level of image data in an analog form and may output the image data with an amplified voltage level to the corresponding data line via an output end. The amplifier AMP may include a positive amplifier AMP_P and a negative amplifier AMP_N. The positive amplifier AMP_P and the negative amplifier AMP_N may be alternately provided. For example, the positive amplifier AMP_P may be provided to be connected to the odd-numbered data line, and the negative amplifier AMP_N may be provided to be connected to the even-numbered data line.

The positive amplifier AMP_P may amplify a voltage level of pixel data in an analog form to generate a positive data voltage and may output the positive data voltage to the corresponding data line via an output end.

The negative amplifier AMP_N may amplify a voltage level of pixel data in an analog form to generate a negative data voltage and may output the negative data voltage to the corresponding data line via an output end.

As in FIG. 3, the amplifier AMP according to the embodiment of the present disclosure may output a voltage within a driving voltage as a data voltage. For example, a high potential voltage VDD and a half VDD HVDD are supplied as driving voltages of the positive amplifier AMP_P. The positive amplifier AMP_P outputs a data voltage within a dynamic range between the high potential voltage VDD and the half VDD HVDD. The half VDD HVDD and a low potential voltage VSS are supplied as driving voltages of the negative amplifier AMP_N. The negative amplifier AMP_N may output a data voltage within a dynamic range between the half VDD HVDD and the low potential voltage VSS. For example, the high potential voltage VDD may be set to 15 V, the low potential voltage VSS may be set to 0 V, and the half VDD HVDD may be set to 7 V, but the embodiments of the present disclosure are not necessarily limited thereto.

The selection circuit 110c may connect an output channel or a data line to the output circuit according to the control signal or may short-circuit adjacent data lines to perform charge sharing between the data lines.

Referring back to FIG. 2, the selection circuit 110c includes first switch elements SW1, second switch elements SW2, and third switch elements SW3. The first switch element SW1 includes a first-P switch element SW1P and a first-N switch element SWIN. The first-P switch element SW1P connects a first contact node a of SW1P connected to the output end of the positive amplifier AMP_P and a second contact node b of SW1P connected to a first output channel OUT(n-1) or connects the first contact node a of SW1P connected to the output end of the positive amplifier AMP P and a third contact node c of SW1P connected to a second output channel OUT (n). The first-N switch element SWIN connects a first contact node a of SWIN connected to the output end of the negative amplifier AMP_N and a second contact node b of SWIN connected to the second output channel OUT (n) or connects the first contact node a of SWIN connected to the output end of the negative amplifier AMP_N and a third contact node c of SWIN connected to the first output channel OUT(n-1).

The second switch element SW2 is connected between the first output channel OUT(n-1) and the second output channel OUT (n). The third switch element SW3 is connected between a power line to which the half VDD HVDD is applied and the first output channel OUT(n-1) or the second output channel OUT (n).

For example, the selection circuit 110c may connect the data line to the output circuit in a display mode, and may perform charge sharing between the data lines in a charge sharing mode.

The charge sharing short-circuits adjacent data lines before the polarity of the data voltage is changed, to average the voltages of the data lines. The data lines include data lines to which the positive data voltage is supplied, and data lines to which the negative data voltage is applied. Accordingly, when the data lines are short-circuited during the execution of the charge sharing mode, the voltages of the data lines become an average voltage between the positive data voltage and the negative data voltage.

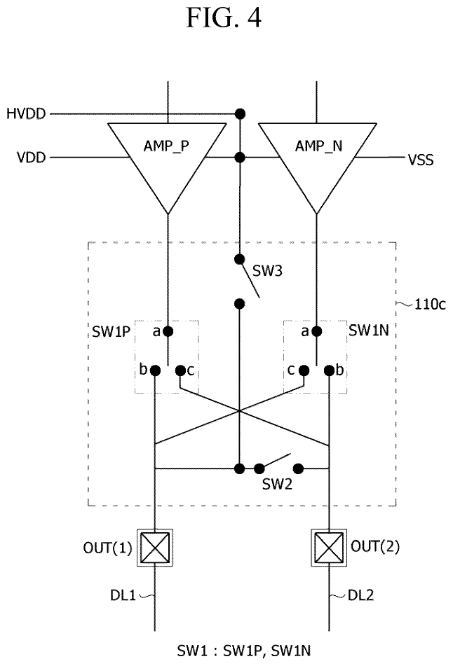

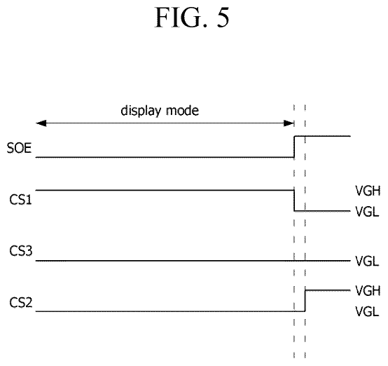

FIGS. 4 and 5 are diagrams illustrating an operation principle of a selection circuit in a display mode.

Referring to FIG. 4, a selection circuit 110c according to the embodiment of the present disclosure may include a first switch element SW1, a second switch element SW2, and a third switch element SW3.

The first switch element SW1 includes a first-P switch element SW1P and a first-N switch element SWIN. The first-P switch element SW1P is connected to an output end of a positive amplifier AMP_P, and the first-N switch element SWIN is connected to an output end of a negative amplifier AMP_N. The first-P switch element SW1P and the first-N switch element SWIN are implemented by a three-way switch, but the embodiments of the present disclosure are not limited thereto.

The first-P switch element SW1P is connected between the positive amplifier AMP_P and a first output channel OUT (1) or a second output channel OUT (2), and the first-N switch element SWIN is connected between the negative amplifier AMP_N and the first output channel OUT (1) or the second output channel OUT (2).

The second switch element SW2 is connected between the first output channel OUT (1) and the second output channel OUT (2).

The third switch element SW3 is connected between a power line to which the half VDD HVDD is applied and the first output channel OUT (1) or between the power line to which the half VDD HVDD is applied and the second output channel OUT (2).

The display mode is driven in a low level interval of a source output enable signal SOE, and in the display mode, as in FIG. 5, the first switch element SW1 may be turned on by a high level of a first control signal CS1, and the second and third switch elements SW2 and SW3 may be turned off by low levels of second and third control signals CS2 and CS3.

In this case, while the first switch element SW1 is turned on by the high level of the first control signal CS1, when the positive data voltage is output, a first contact a may be connected to a second contact b, and when negative data voltage is output, the first contact a may be connected to a third contact c. When the first switch element SW1 is turned off by a low level of the first control signal CS1, the first contact a is not connected to the second contact b and the third contact c.

When pixel data is applied, while the first switch element SW1 is turned on, and the second switch element SW2 and the third switch element SW3 are turned off, the first contact a of the first-P switch element SW1P is connected to the second contact b, so that the positive amplifier AMP_P may output the positive data voltage to a first data line DL1 via the first output channel OUT (1), and the first contact a of the first-N switch element SWIN is connected to the second contact b, so that the negative amplifier AMP_N may output the negative data voltage to a second data line DL2 via the second output channel OUT (2).

When the polarity of the pixel data is inverted, while the first switch element SW1 is turned on, and the second and third switch elements SW2 and SW3 are turned off, the first contact a of the first-P switch element SW1P is connected to the third contact c, so that the positive amplifier AMP_P may output the positive data voltage to the second data line DL2 via the second output channel OUT (2), and the first contact a of the first-N switch element SWIN is connected to the third contact c, so that the negative amplifier AMP_N may output the negative data voltage to the first data line DL1 via the first output channel OUT (1).

The data driver applies pixel data, performs charge sharing, then, inverts the polarity of the pixel data, and applies the pixel data with the inverted polarity. In this case, during charge sharing after pixel data of a low grayscale is applied, a charge sharing time for which a relatively small number of charges are moved is sufficient. On the other hand, during charge sharing after pixel data of a high grayscale is applied, a charge sharing time for which a relatively large number of charges are moved is not sufficient.

To solve this problem, the charge sharing time is extended during charge sharing at the high grayscale.

However, when the charge sharing time during charge sharing after the pixel data of the high grayscale is output is extended, a charging time of next pixel data may be affected. That is, the charging time of the next pixel data is reduced by the charge sharing time. Accordingly, in the embodiment, the charge sharing time is extended only when the pixel data of the low grayscale is output after the pixel data of the high grayscale is output such that there is little influence even when the charging time is reduced.

Accordingly, in the embodiment, during charge sharing, a predetermined first charge sharing time or a second charge sharing time may be selectively provided according to change in grayscale of pixel data. The second charge sharing time may be a time expanded from the first charge sharing time. Accordingly, the second charge sharing time is longer than the first charge sharing time.

Further, in the embodiment, when the grayscale of the pixel data changes, that is, when the grayscale of the pixel data changes from a high grayscale to a low grayscale, the data lines are made to rapidly reach the half VDD HVDD by supplying the half VDD HVDD to the short-circuited data lines while extending the charge sharing time during the charge sharing. The charges are additionally supplied to the data lines by the half VDD HVDD.

Here, although a case where the half VDD HVDD is applied during charge sharing has been described as an example, the embodiments of the present disclosure are not limited thereto, and a voltage of a predetermined level may be applied.

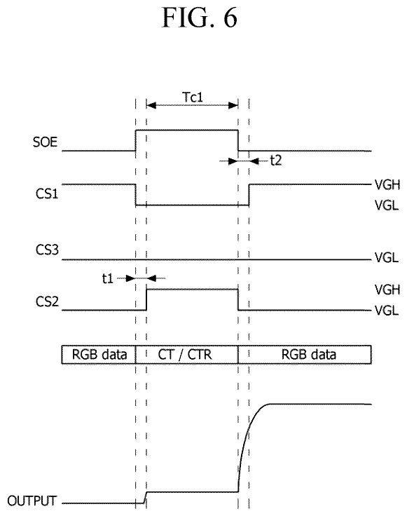

FIGS. 6 to 9 are diagrams illustrating an operation principle of the selection circuit in a charge sharing mode.

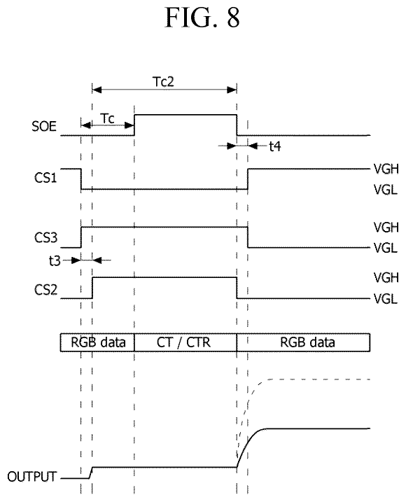

In FIGS. 6 and 8, the first to third control signals CS1 to CS3 may be signals for turning on or off the first to third switch elements SW1 to SW3, respectively.

In the embodiment, during charge sharing after the pixel data of the low grayscale is output, the first charge sharing time is provided regardless of the grayscale of the next pixel data.

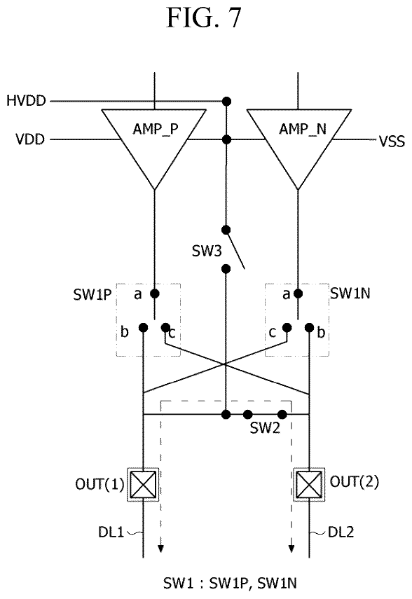

Referring to FIGS. 6 and 7, in the embodiment, after the pixel data of the low grayscale is applied, the first switch element SW1 and the third switch element SW3 are turned off by a low level of the first control signal CS1 and the third control signal CS3, the second switch element SW2 is turned on by a high level of the second control signal CS2, and charge sharing may be performed for a first charge sharing time Tc1.

The first control signal CS1 may transit to the low level conforming to a rising time of the source output enable signal SOE, and the first switch element SW1 may be turned off. The second control signal CS2 transits to the high level after a predetermined time t1, and the second switch element SW2 is turned on. In this case, since the third control signal CS3 is maintained at the low level, the third switch element SW3 is maintained in a turn-off state.

The second control signal CS2 may transit to the low level conforming to a falling time of the source output enable signal SOE, and the second switch element SW2 may be turned off. The first switch element SW1 is turned on after a predetermined time t2. In this case, since the third control signal CS3 is maintained at the low level, the third switch element SW3 is maintained in the turn-off state.

In this way, in the embodiment, for the first charge sharing time Tc1 before the polarity is inverted after the pixel data of the low grayscale is output, the second switch element SW2 is turned on, and the charge sharing is performed.

In the embodiment, the second charge sharing time is provided when pixel data of a low grayscale is output as next pixel data during charge sharing after pixel data of a high grayscale is output.

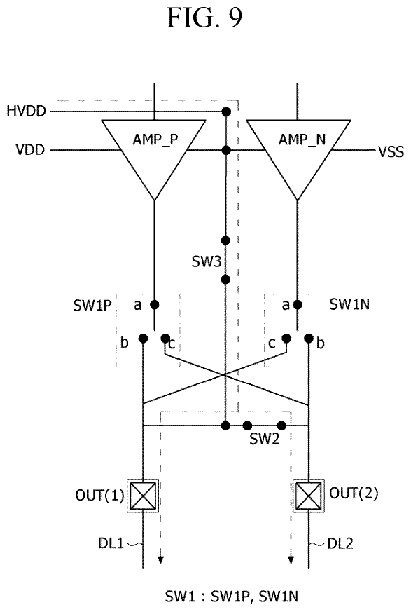

Referring to FIGS. 8 and 9, in the embodiment, before the source output enable signal SOE transits to the high level after the pixel data of the high grayscale is applied, the first switch element SW1 may be turned off, the second and third switch elements SW2 and SW3 may be turned on, and the charge sharing may be performed for a second charge sharing time Tc2. The second charge sharing time Tc2 may be longer than the first charge sharing time Tc1.

The first switch element SW1 may be turned off conforming to a time earlier than the rising time of the source output enable signal SOE by a predetermined time Tc, and the third switch element SW3 may be turned on. The second switch element SW2 may be turned on after a predetermined time t3.

The second switch element SW2 may be turned off conforming to the falling time of the source output enable signal SOE. The first switch element SW1 and the third switch element SW3 may be turned off after a predetermined time t4.

The second switch element SW2 is turned on after the third switch element SW3 is turned on, and is turned off at the falling time of the source output enable signal SOE. The second switch element SW2 is turned on at the predetermined time t3 after the first switch element SW1 is turned off. The first switch element SW1 is turned on at the predetermined time t4 after the second switch element SW2 is turned off. The first switch element SW1 and the second switch element SW2 are not turned on or off simultaneously. The reason is because an output buffer is connected to the first and second output channels and a driving current of the output buffer flows into the first and second output channels when the second switch element SW2 is turned on in a state in which the first switch element SW1 is turned on.

In this case, t3 and t4 may be the same times as t1 and t2 in FIG. 6, respectively, but the embodiments of the present disclosure are not limited thereto.

In this way, in the embodiment, charge sharing may be performed for the second charge sharing time Tc2 longer than the first charge sharing time Tel before the polarity is inverted after the pixel data of the high grayscale is output.

In the embodiment, determination may be made whether to apply the first charge sharing time or the second charge sharing time according to change in grayscale of pixel data that is applied before and after charge sharing. To this end, the grayscale of the pixel data is determined using most significant two bits of the pixel data.

For example, when values of upper two bits of the pixel data are [A, B]=[1, 1] or [1, 0], determination may be made to be the high grayscale, and when [A, B]=[0, 1] or [0, 0], determination may be made to be the low grayscale.

To this end, in the embodiment, a determination circuit that determines the grayscale of the pixel data may be provided.

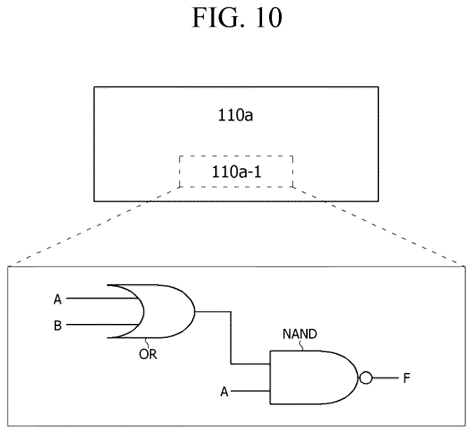

FIG. 10 is a diagram illustrating a grayscale determination principle according to the embodiment of the present disclosure.

Referring to FIG. 10, the control circuit 110a in the data driver according to the embodiment of the present disclosure may include a determination circuit 110a-1 for determining the grayscale of the pixel data.

The determination circuit 110a-1 may include an OR gate OR and a NAND gate NAND as in FIG. 10. The OR gate OR may receive the upper two bits A and B and output a result value of an OR operation, and the NAND gate NAND may receive the result value of the OR gate OR and the A bit as the most significant bit (MSB) and outputs a result value of a NAND operation.

As an example, the OR gate OR in the determination circuit 110a-1 may receive the upper two bits A=1 and B=1 and output “1” as the result value of the OR operation, and the NAND gate NAND may receive “1” as the result value of the OR operation and A=1 and output “0” as the result value of the NAND operation.

As another example, the OR gate OR in the determination circuit 110a-1 may receive the upper two bits A=0 and B=0 and output “0” as the result value of the OR operation, and the NAND gate NAND may receive “0” as the result value of the OR operation and A=0 and output “1” as the result value of the NAND operation.

The determination circuit 110a-1 may output the result value using the upper two bits as in Table 1 described below and may determine the grayscale of the pixel data based on the output result value. That is, when the result value is “0,” determination may be made to be the high grayscale, and when the result value is “1,” determination may be made to be the low grayscale.

TABLE 1

| A | B | F |
|---|---|---|
| 0 | 0 | 1 |
| 1 | 0 | 0 |
| 0 | 1 | 1 |
| 1 | 1 | 0 |

In this way, the control circuit 110a may determine the grayscale of pixel data which is currently applied, on the basis of the result value output from the determination circuit 110a-1. However, when the charge sharing time is extended according to the grayscale of the pixel data, the charging time of next pixel data may be affected. That is, the charging time of the next pixel data is reduced by the charge sharing time. Accordingly, in the embodiment, the charge sharing time is extended only when pixel data of a low grayscale is output after pixel data of a high grayscale is output such that there is little influence even when the charging time is reduced.

In the embodiment, determination may be made whether to select the first charge sharing time or the second charge sharing time on the basis of change in grayscale between pixel data which is currently applied and pixel data which is next applied.

For example, the control circuit 110a may select the first charge sharing time when the result value output from the determination circuit 110a-1 is changed from “1” (for example, low grayscale) to “0” (for example, high grayscale), and may select the second charge sharing time when the result value output from the determination circuit 110a-1 is changed from “0” (for example, high grayscale) to “1” (for example, low grayscale).

That is, only when the result value output from the determination circuit 110a-1 is changed from “0” to “1,” determination is made that pixel data of a high grayscale is applied, charge sharing is performed, and then, pixel data of a low grayscale is applied as next pixel data, and the charge sharing time is extended.

Here, the high grayscale may be a grayscale included in a predetermined first grayscale interval, and the low grayscale may be a grayscale included in a second grayscale interval set lower than the first grayscale interval. Although a case where the entire grayscale is divided into the first grayscale interval and the second grayscale interval has been described herein as an example, the embodiments of the present disclosure are not limited thereto, and the entire grayscale may be divided into three or more grayscale intervals.

In the embodiment, a data packet is to be used to set the charge sharing time.

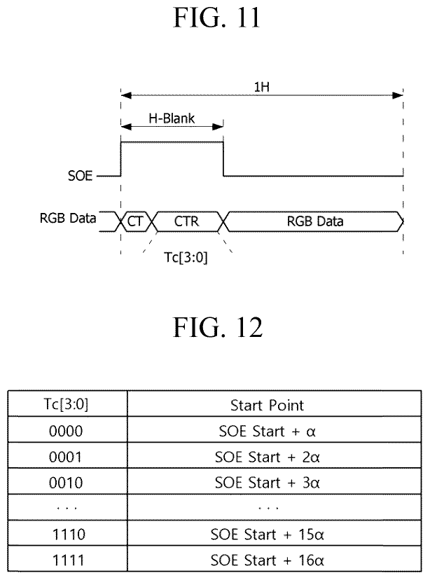

FIGS. 11 and 12 are diagrams illustrating a data packet according to the embodiment of the present disclosure.

Referring to FIGS. 11 and 12, the timing controller may transmit a data packet including time information determined according to the electrical characteristics of the display device to the data driver.

The data packet may include clock training data CT, control data CTR, and pixel data RGB Data.

Time information Tc for extending the charge sharing time may be included in the control data CTR that is transmitted in a horizontal blank period H-Blank before the pixel data RGB Data is transmitted.

The time information Tc may be implemented as four bits, but the embodiments of the present disclosure are not limited thereto. The time information may be set in advance as in FIG. 12, and may be different according to the electrical characteristics of the display device. Here, a start point of the charge sharing time may be a time earlier than the rising time (SOE Start) of the source output enable signal by a predetermined time a.

Accordingly, the predetermined time Tc in FIG. 8 may be set to Tc=n× a (where n is a natural number).

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data driver comprising:
a voltage output circuit including a first amplifier and a second amplifier, the first amplifier configured to amplify input positive pixel data and output the amplified positive pixel data as a positive data voltage, the second amplifier configured to amplify negative pixel data and output the amplified negative pixel data as a negative data voltage;
a selection circuit configured to alternately connect the first amplifier and the second amplifier to different ones of a first data line and a second data line, and connect the first and second data lines to one another in a charge sharing time before the connecting the first amplifier and the second amplifier to different ones of the first data line and the second data line has been alternated; and
a control circuit configured to vary the charge sharing time based on a grayscale of input pixel data.

2. The data driver according to claim 1, wherein the control circuit is configured to:
control the selection circuit to connect the first and second data lines for a first charge sharing time in response to both a first grayscale of pixel data input before the charge sharing and a second grayscale of pixel data input after the charge sharing are within a first grayscale range; and
control the selection circuit to connect the first and second data lines for a second charge sharing time longer than the first charge sharing time in response to the first grayscale of the pixel data input before the charge sharing and the second grayscale of the pixel data input after the charge sharing are within a second grayscale range lower than the first grayscale range.

3. The data driver according to claim 2,
wherein the first charge sharing time is within a high level range of a source output enable signal, and
the second charge sharing time overlaps the high level range of the source output enable signal and is greater than the high level range of the source output enable signal.

4. The data driver according to claim 2, wherein the selection circuit includes:
a first-P switch element configured to connect the first amplifier to one of the first data line or the second data line;
a first-N switch element configured to connect the second amplifier to another one of the second data line or the first data line; and
a second switch element configured to connect the first data line and the second data line.

5. The data driver according to claim 4, wherein the selection circuit further includes:
a third switch element configured to connect a power line configured to receive a voltage of a level and one of the first data line or the second data line.

6. The data driver according to claim 5, wherein:
driving voltages of the first amplifier are a high potential voltage and the voltage of the level, and
driving voltages of the second amplifier are the voltage of the level and a low potential voltage.

7. The data driver according to claim 5, wherein, for the first charge sharing time, the first-P switch element, the first-N switch element, and the third switch element are configured to be turned off, and the second switch element is configured to be turned on.

8. The data driver according to claim 5, wherein, for the second charge sharing time, the first-P switch element and the first-N switch element are configured to be turned off, and the second and third switch elements are configured to be turned on.

9. The data driver according to claim 8, wherein the second switch element is configured to be turned on after the third switch element is turned on.

10. A display device comprising:
a display panel in which a plurality of data lines, a plurality of gate lines, and a plurality of pixel circuits are provided;
a data driver configured to output data voltages to the plurality of data lines; and
a gate driver configured to output gate signals to the plurality of gate lines,
wherein the data driver includes:
a voltage output circuit including a first amplifier configured to amplify input positive pixel data and output the amplified positive pixel data as a positive data voltage and a second amplifier configured to amplify negative pixel data and output the amplified pixel data as a negative data voltage;
a selection circuit configured to connect the first amplifier and the second amplifier to a first data line and a second data line, respectively, in a first voltage polarity period, connect the first amplifier and the second amplifier to the second data line and the first data line, respectively, in a second voltage polarity period, and connect the first and second data lines to one another in a charge sharing period between the first polarity period and the second polarity period; and
a control circuit configured to vary a time of the charge sharing period based on a grayscale of input pixel data.

11. The display device according to claim 10, wherein the control circuit is configured to:
control the selection circuit to connect the first and second data lines for a first charge sharing time in response to both a first grayscale of pixel data input before the charge sharing and a second grayscale of pixel data input after the charge sharing are within a first grayscale range; and
control the selection circuit to connect the first and second data lines for a second charge sharing time longer than the first charge sharing time in response to the first grayscale of the pixel data input before the charge sharing and the second grayscale of the pixel data input after the charge sharing are within a second grayscale range lower than the first grayscale range.

12. The display device according to claim 11, wherein:
the first charge sharing time is within a high level range of a source output enable signal, and
the second charge sharing time overlaps the high level range of the source output enable signal and is greater than the high level range of the source output enable signal.

13. The display device according to claim 11, wherein the selection circuit includes:
a first-P switch element configured to connect the first amplifier to one of the first data line or the second data line;
a first-N switch element configured to connect the second amplifier to another one of the second data line or the first data line; and
a second switch element configured to connect the first data line and the second data line to one another.

14. The display device according to claim 13, wherein the selection circuit further includes:
a third switch element configured to connect a power line configured to receive a voltage of a level and one of the first data line or the second data line.

15. The display device according to claim 14, wherein:
driving voltages of the first amplifier are a high potential voltage and the voltage of the level, and
driving voltages of the second amplifier are the voltage of the level and a low potential voltage.

16. The display device according to claim 14, wherein, for the first charge sharing time, the first-P switch element, the first-N switch element, and the third switch element are configured to be turned off, and the second switch element is configured to be turned on.

17. The display device according to claim 14, wherein, for the second charge sharing time, the first-P switch element and the first-N switch element are configured to be turned off, and the second and third switch elements are configured to be turned on.

18. The display device according to claim 17, wherein the second switch element is configured to be turned on after the third switch element is turned on.

19. The display device according to claim 10, further comprising:
a timing controller configured to transmit, to the control circuit, a data packet including time information for varying the charge sharing time.

20. A display device, comprising:
a voltage output circuit including a first amplifier and a second amplifier, the first amplifier configured to amplify input positive pixel data and output a positive data voltage, the second amplifier configured to amplify negative pixel data and output a negative data voltage;
a selection circuit coupled to the voltage output circuit, and configured to connect an output of the first amplifier to a first data line and connect an output of the second amplifier to a second data line in a first voltage polarity period and connect the output of the first amplifier to the second data line and connect the output of the second amplifier to the first data line in a second voltage polarity period, and the selection circuit including a switch connected between the first data line and the second data line; and
a control circuit configured to vary, based on a grayscale of input pixel data, a time period that the switch is turned on between the first voltage polarity period and the second voltage polarity period.
